(19) United States
(12) Patent Application Publication
(10) Pub. No.: US 2022/0401897 A1
(43) Pub. Date: Dec. 22, 2022

(54) Method and Device for Producing a Carbonated Beverage

(71) Applicant: Freezio AG, Amriswil (CH)

(72) Inventors: Marc Krüger, Bergisch Gladbach (DE); Günter Empl, Bergisch Gladbach (DE); Daniel Fischer, Romanshorn (CH); Remo Sonderegger, Tägerwilen (CH)

(21) Appl. No.: 17/771,947

(22) PCT Filed: Nov. 4, 2020
(86) PCT No.: PCT/EP2020/080961

§ 371 Date: Apr. 26, 2022

(30) Foreign Application Priority Data
Nov. 8, 2019 (DE) 10 2019 217 331.4

(51) Int. Cl. B01F 23/236; B01F 35/83; B01F 23/237; A23L 2/54; B01F 23/40; B67D 1/00

(52) U.S. Cl. CPC B01F 23/2363; B01F 35/83; B01F 23/237621; A23L 2/54; B01F 23/483; B67D 1/0058; B01F 2215/0468; B01F 2215/045; B01F 2215/0472; B01F 25/43141

(57) ABSTRACT

The invention relates to a method for producing a beverage in portions, wherein a beverage concentrate portion is mixed with a water portion, said water portion being mixed with carbon dioxide prior to being mixed with the beverage concentrate. The invention additionally relates to a device for producing a beverage in portions, wherein a beverage concentrate portion is mixed with a water portion, said water portion being mixed with carbon dioxide in a static mixer prior to being mixed with the beverage concentrate.

The invention relates to a method for portionwise preparation of a beverage, in which a portion of beverage concentrate is mixed with a portion of water, wherein the portion of water is admixed with carbon dioxide prior to mixing with the beverage concentrate. The present invention further relates to a device for portionwise preparation of a beverage, in which a portion of beverage concentrate is mixed with a portion of water, wherein the portion of water is admixed with carbon dioxide in a static mixer prior to mixing with the beverage concentrate.

The need for portionwise preparation of carbonated beverages using a portion of beverage concentrate is constantly increasing. However, the often insufficient carbonation in the past meant that the beverage prepared portionwise using a portion of beverage concentrate did not taste like the bottled or kegged original.

It is therefore an object of the invention to provide a method and a device for portionwise preparation of a beverage, in which a portion of beverage concentrate is mixed with a portion of water, which method/device does not have the disadvantages of the prior art.

The object is achieved with a method for portionwise preparation of a beverage, in which a portion of beverage concentrate is mixed with a portion of water, wherein the portion of water is admixed with carbon dioxide prior to mixing with the beverage concentrate, in which the admixing with carbon dioxide is done at a positive pressure of at least 7 bar, preferably >8 bar, particularly preferably at 9-11 bar.

The disclosure made in relation to this subject of the present invention also applies to the other subjects of the present invention. Features disclosed in connection with this subject of the present invention can also be incorporated into other subjects.

The present invention relates to a method for portionwise preparation of a beverage. Provided for this purpose, especially in disposable or reusable packaging, is a portion of beverage concentrate, the liquid or powdered content of which is mixed with a portion of water, especially a portion of tap water, which forms the completed beverage. Prior to mixing with the beverage concentrate, the water admixed with carbon dioxide admixed with carbon dioxide bubbles, and the carbon dioxide at least partially, preferably completely, dissolved in the water. The admixing of the water with the carbon dioxide is preferably likewise done portionwise and particularly preferably done immediately before the carbonated water is mixed with the beverage concentrate.

The admixing of the water with the carbon dioxide is preferably done in a continuous process in which water and carbon dioxide are admixed in a ratio attuned to one another.

According to the invention, a positive pressure of at least 7 bar, preferably >8 bar, particularly preferably at 9-11 bar, prevails during the admixing of the water with carbon dioxide. As a result, the carbon dioxide at least substantially dissolves in the water, preferably completely.

The portion of water is preferably taken from a water tank and brought to the desired pressure using a pump. The carbon dioxide is preferably taken from a pressure cylinder.

The mixing of water and carbon dioxide is preferably done portionwise, but particularly preferably continuously while the water is flowing, is in particular being taken from a water tank for beverage preparation.

According to a preferred embodiment, the water is provided at a temperature of 0-4° C. prior to mixing with carbon dioxide. According to a further preferred embodiment, the water is provided at a temperature of 4-10° C. prior to mixing with carbon dioxide. For this purpose, the water is preferably cooled, especially in a heat exchanger, after removal from the water tank. The cooling of the water is preferably done portionwise.

The carbon dioxide is preferably added to the water at least substantially in the form of bubbles. Preferably, the carbon dioxide is dissolved in the water by mixing the carbon dioxide with the water in a static mixer, though, according to another preferred embodiment, a dynamic mixer, i.e., a mixer with a rotor, is alternatively or additionally used. Particularly preferably, the flow rate in the static mixer is 3-8 m/s.

A reduced pressure compared to the operating conditions, preferably ambient pressure, preferably prevails in the static mixer before and after the preparation of the portion of carbonated water. As soon as the volume of water required for the preparation of a portion of beverage has been carbonated, the pump is switched off and the pressure in the static mixer is reduced, preferably to ambient pressure.

According to a preferred embodiment, the ratio of the amount of water to the amount of carbon dioxide is regulated. For this purpose, the volumetric flow rate and/or the flow rate of the water is particularly preferably measured and the volumetric flow rate of the carbon dioxide is metered in accordingly.

The object is also achieved with a device for portionwise preparation of a beverage, in which a portion of beverage concentrate is mixed with a portion of water, wherein the portion of water is admixed with carbon dioxide in a static mixer prior to mixing with the beverage concentrate and the static mixer is formed of multiple mixer stages.

The disclosure made in relation to this subject of the present invention also applies to the other subjects of the present invention. Features disclosed in connection with this subject of the present invention can also be incorporated into other subjects.

This subject of the present invention relates to a device for portionwise preparation of a beverage. A portion of water is mixed with a portion of a beverage concentrate, resulting in the beverage to be prepared. The water is carbonated prior to mixing with the beverage concentrate. For this purpose, carbon dioxide is added to the water and they are mixed together in a static mixer in such a way that the carbon dioxide metered in at least substantially dissolves in the water.

According to the invention, the static mixer has multiple mixer stages which are, for example, separated from one another by a wall having a hole. The water and the carbon dioxide flow through the hole.

Preferably, the static mixer is manufactured as a single piece, preferably as a plastic injection-molded part.

Preferably, the exit of a downstream mixer stage forms a nozzle for the upstream mixer stage adjacent thereto.

Preferably, the flow cross section of the static mixer decreases in the direction of flow, preferably in steps.

Preferably, two to four, preferably four, static mixers, especially static mixers of identical construction, are connected in series.

Preferably, a compensator is provided downstream of the static mixer. The carbonated water flows through the compensator before it is used to prepare a beverage. The compensator can be used for pressure reduction in which little gas outgasses from the liquid.

The compensator is preferably a substantially rotationally symmetrical component.

Preferably, the compensator has an inlet and an outlet, and the outlet is offset from the longitudinal central axis of the compensator. According to this preferred embodiment of the present invention, the outlet is offset from the longitudinal central axis of the compensator, preferably eccentric to the longitudinal central axis of the compensator. As a result, the center of the compensator is free and can be used for other purposes, for example for regulation of pressure loss.

Preferably, the compensator has a housing in which a fitted element is present, wherein a gap, the width of which is preferably adjustable, is present between the housing and the fitted element. The carbonated water flows through this gap from the inlet of the compensator to the outlet thereof. The gap width is preferably constant over its entire length.

Preferably, the fitted element has a conical and a cylindrical section, wherein the cylindrical section has provided thereon projections and/or indentations, the length of which in the longitudinal direction is at most 40% of the length of the cylindrical part.

According to a preferred embodiment, the conical part of the fitted element has provided thereon ribs, which are preferably elastic. The ribs can consist of the same material as or a different material than the fitted element and/or be a characteristic of the conical part of the fitted element. Preferably, the fitted element has provided therein indentations which receive the ribs interlockingly and/or frictionally.

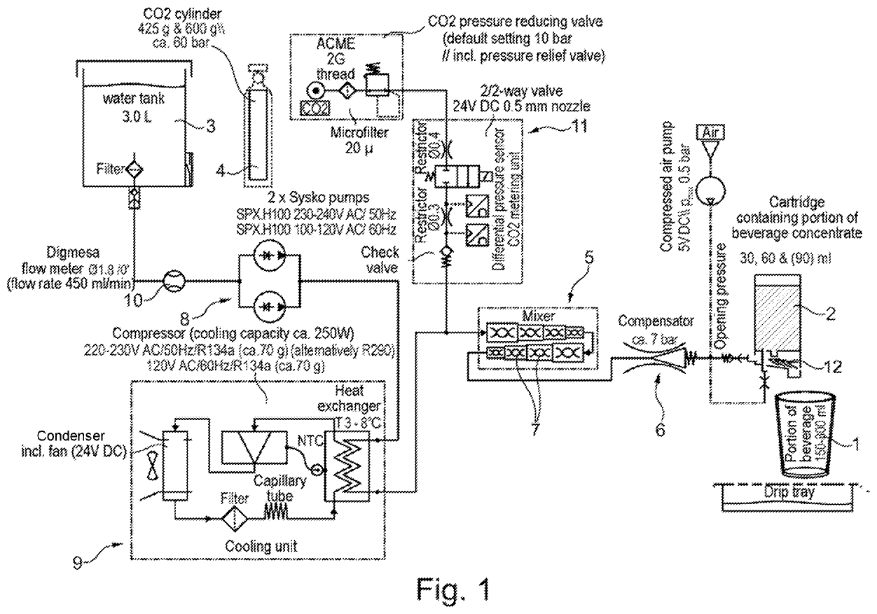

In what follows, the invention will be explained with reference to FIGS. 1-4.

FIG. 1 shows schematically the method according to the invention.

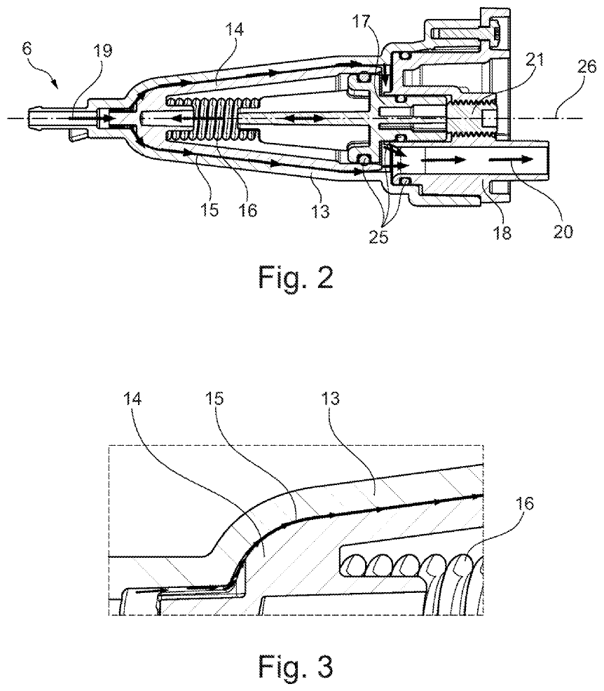

FIGS. 2-4 each show a depiction of the compensator.

These explanations are merely by way of example and do not limit the general concepts of the invention. These explanations apply equally to all subjects of the present invention.

FIG. 1 shows the device for preparation of a beverage 1. To prepare the beverage, a beverage concentrate, which is provided in the present case as portion 2 in disposable or reusable packaging, for example a plastic or metal cartridge, is mixed with a portion of water, for example 200 ml, and then collected in a container. The water is provided in the water tank 3 and brought to the desired pressure of at least 7 bar by means of the pump 8, in this case two parallelly connected or redundant pumps. The flow rate running from the tank 3 into the container 1 is preferably monitored by means of a flow meter 10, which preferably also controls the pumps such that the desired volume of water is conveyed. To prepare a beverage, the pump is preferably switched on and, after the desired amount of water has been obtained, switched off. Preferably, the water is cooled, especially before carbonation thereof. Provided for this purpose is a water cooling system comprising a heat exchanger with a cooling water circuit. The CO₂ is preferably metered into the water after cooling. The CO₂ is taken from a carbon dioxide supply 4, in this case a pressure cylinder, and metered, especially in the form of bubbles, into the water by means of a CO₂ metering system 11. Preferably, CO₂ metering is done depending on the water flow rate, which is ascertained by means of the flow meter 10. Provided downstream of the CO₂ metering system is a mixer, in this case a static mixer 5 having in this case two stages, it being possible for each stage to preferably comprise multiple mixer stages. The static mixer is preferably constructed in such a way that the flow cross section decreases after each mixer stage in the direction of flow. Preferably, the two stages of the static mixer are uniform. Preferably, the static mixer is a plastic part, especially a plastic injection-molded part. In the static mixer, the CO₂ metered in in the form of bubbles is dissolved in the water, preferably completely in particular. Provided downstream of the static mixer is a compensator, by means of which the pressure in the static mixer can be adjusted. According to the invention, said pressure should be at least 7 bar.

Preferably, the residence time of the water between the static mixer and the chamber 12, in which the carbonated water is mixed with the portion of beverage concentrate, is as short as possible. The completed beverage runs out of the beverage concentrate portion capsule 2 and is collected in a container, in this case a glass. The beverage concentrate is preferably pushed out of the portion capsule 2 by means of air.

FIGS. 2 to 4 each show a depiction of the compensator 6. The compensator 6 is provided downstream of the mixer 5. The compensator 6 has a housing 13 in which a fitted element 14 is provided. In the present case, the fitted element 14 and the housing 13 are substantially rotationally symmetrical. The compensator 6 has a longitudinal central axis 26. Present in the housing 13 is an inlet 19 through which the carbonated water flows in and then flows in the direction of the outlet 20 within a gap 15 present between the housing 13 and the fitted element 14. In the present case, the outlet 20 is offset from the longitudinal central axis 26. Furthermore, the outlet in the present example is provided in an insert 18, which is inserted into the housing 13. Provided between the fitted element and the insert 18 is an adjustment means 17, which can be adjusted in the directions depicted by the double arrow by means of the screw 21, which in the present case with a thread present in the insert 18. As a result, the width of the gap 15 and thus the pressure loss that occurs in the compensator can be adjusted. In the present case, what is provided between the adjustment means 17 and the fitted element 14 is a spring element 16, which attempts to prestress the fitted element in the direction of the inlet and/or in the direction of a smallest possible gap. What can be provided both on the adjustment means 17 and on the insert 18 are sealing elements 25, which prevent the water flowing in the direction of the outlet from leaving the compensator at undesired points.

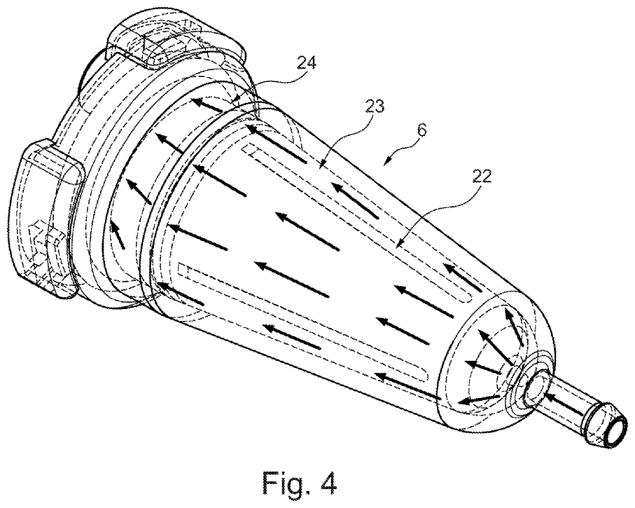

As can be seen in FIG. 4 in particular, the fitted element 14 has here a conical part 23 and a cylindrical part 24. As can likewise be seen in FIG. 4 in particular, the conical part in particular preferably has provided thereon ribs 22, which space the fitted element from the housing and thereby provide channels 15 through which the liquid can flow from the inlet in the direction of the outlet, as depicted by the arrows.

### LIST OF REFERENCE SIGNS

1 Beverage
2 Portion of beverage concentrate, beverage concentrate portion capsule
3 Portion of water, water tank
4 Carbon dioxide, carbon dioxide supply
5 Mixer, static mixer
6 Compensator
7 Mixer stage
8 Pump
9 Water cooling system
10 Flow meter
11 CO₂ metering system
12 Mixing chamber
13 Housing
14 Fitted element
15 Flow channel between the housing and the fitted element
16 Spring means
17 Adjustment means to adjust the width of the flow channel
18 Insert
19 Inlet
20 Outlet
21 Screw, nut
22 Rib
23 Conical part of the fitted element 14
24 Cylindrical part of the fitted element 14
25 Seal
26 Longitudinal central axis

1. A method for portionwise preparation of a beverage comprising:
a) admixing a portion of water with carbon dioxide in a static mixer at a positive pressure of about 7 bar or greater;
b) mixing a portion of beverage concentrate with the portion of water;
wherein the portion of water is admixed with carbon dioxide prior to mixing with the beverage concentrate; and,
wherein a compensator is provided downstream of the static mixer.

2. The method as claimed in claim 1, wherein the water is provided at a temperature of 0° C. to about −10° C. prior to mixing with carbon dioxide.

3. (canceled)

4. The method as claimed in claim 1, wherein a flow rate in the static mixer is about 3 m/s to about −8 m/s.

5. (canceled)

6. The method as claimed in claim 1, wherein a reduced pressure compared to operating conditions is present in the static mixer before and after the preparation of the portion of water.

7. The method as claimed in claim 1, wherein a ratio of an amount of water to an amount of carbon dioxide is regulated.

8. A device for portionwise preparation of a beverage comprising:
a) a cartridge containing a portion of beverage concentrate;
b) a water tank containing water;
c) a static mixer having multiple mixer stages; and
d) a compensator downstream of the static mixer;
wherein a portion of the beverage concentrate is mixed with a portion of the water; and
wherein the portion of water is admixed with carbon dioxide in the static mixer prior to mixing with the beverage concentrate.

9. The device as claimed in claim 8, wherein the exit of a downstream mixer stage forms a nozzle for an upstream mixer stage adjacent thereto.

10. The device as claimed in claim 8, wherein a flow cross section of the static mixer decreases in the direction of flow.

11. The device as claimed in claim 10, wherein the flow cross section decreases in steps.

12. (canceled)

13. The device as claimed in claim 8, wherein the compensator has an inlet and an outlet, and the outlet is offset from a longitudinal central axis of the compensator.

14. The device as claimed in claim 8, wherein the compensator has a housing, wherein within the housing is a fitted element having a conical section and a cylindrical section, wherein the cylindrical section has provided thereon projections and/or indentations, the length of which in a longitudinal direction is at most 40% of a length of the cylindrical part.

15. The device as claimed in claim 14, wherein the conical part has provided thereon ribs.

16. The method as claimed in claim 1, wherein the admixing with carbon dioxide is done at a positive pressure of greater than about 8 bar.

17. The method as claimed in claim 16, wherein the admixing with carbon dioxide is done at a positive pressure of about 9 bar to about 11 bar.

18. The method as claimed in claim 2, wherein the water is provided at a temperature of 0° C. to about 4° C. prior to mixing with carbon dioxide.

19. The method as claimed in claim 6, wherein the reduced pressure is ambient pressure.

20. The device as claimed in claim 13, wherein the outlet is eccentric to the longitudinal axis of the compensator.

21. The device as claimed in claim 13, wherein the compensator has a housing, wherein within the housing is a fitted element having a conical section and a cylindrical section, wherein the cylindrical section has provided thereon projections and/or indentations, the length of which in a longitudinal direction is at most 40% of a length of the cylindrical part.

22. The device as claimed in claim 21, wherein the conical part has provided thereon ribs.

23. The device as claimed in claim 15, wherein the ribs are elastic.
